(19) United States
(12) Patent Application Publication
(10) Pub. No.: US 2021/0355895 A1
(43) Pub. Date: Nov. 18, 2021

(54) Throttle Body Spacing Block with Individual Rings in Grooved Aperture for Manipulating Airflow in Internal Combustion Engines

(71) Applicants: Larry Patterson, Searcy, AR (US); Jerry Brown, Searcy, AR (US); Adam Patterson, Searcy, AR (US)

(72) Inventors: Larry Patterson, Searcy, AR (US); Jerry Brown, Searcy, AR (US); Adam Patterson, Searcy, AR (US)

(21) Appl. No.: 15/930,555

(22) Filed: May 13, 2020

(51) Int. Cl. F02M 35/10

(52) U.S. Cl. CPC F02M 35/10262

(57) ABSTRACT

A device for connecting to the intake manifold of an internal combustion engine, the device having at least one grooved aperture for manipulating airflow through the device as the airflow moves into the intake manifold of the engine. The grooved aperture consists of a series of concentric and parallel grooved sections, each section having a minor diameter and a major diameter and incrementally increasing diameters therebetween, such that each section forms a frustum, such that the length of the aperture has a grooved internal surface that provides structure for manipulating the airflow through the device.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Diesel fuel produces various harmful emissions when it is burned. For this reason, diesel-fueled vehicles are major sources of harmful pollutants. While the EPA has established various fuel standards to help reduce the effects of these pollutants on the environment, diesel fuel still contributes to air pollution. According to a 2018 study by the U.S. Energy Information Administration (EIA), diesel fuel consumption in the U.S. transportation sector accounted for about 24% of the total. U.S. transportation sector carbon dioxide emissions and about 9% of the total U.S. energy-related carbon dioxide emissions in 2018. Given the disastrous effects climate change is having on our planet, there have been many attempts through legislation and through innovation to reduce the amount of harmful pollutants emitted into our atmosphere. Most products on the market today, however, are designed to improve air quality only after the harmful emissions are created within the engine.

The use of throttle body spacing blocks, or throttle body spacing blocks, is well known in the prior art. In fact, throttle body spacing blocks are frequently found in the automotive part after-market. Such throttle body spacing blocks are used to separate the existing throttle body, throttle body injection unit and/or carburetor from the intake manifold of an internal combustion engine found in automobiles. The increased space allows the incoming air charge to increase velocity prior to entering the combustion chamber of the engine. The increased air velocity serves to improve the efficiency of the internal fuel combustion. The throttle body spacing blocks heretofore devised and utilized for the purpose of a throttle body spacing block are known to consist basically of familiar, expected, and obvious structural configurations, notwithstanding the vast array of designs for any and all internal combustion engines encompassed by the crowded prior art that has been developed for the fulfillment of countless objectives and requirements.

Many existing throttle body spacing blocks include smooth apertures through which air passes to reach the intake manifold. The increased distance created by the spacing plate allows the incoming air charge to increase velocity as it enters into the intake manifold. Therefore, the throttle body spacing block only provides “extra” space which allows the incoming air charge to increase velocity through inertia. But these devices do not provide any means by which to directly increase the velocity of the air charge or to turbinate the air charge as it passes through the aperture. One example of existing technology aimed at solving this problem is presented in U.S. Pat. No. 6,338,335 to Patterson et al., which is incorporated herein by reference in its entirety. The '335 patent describes a spacing block having grooved aperture(s) that manipulate the incoming air charge of internal combustion engines, where the aperture(s) present a helical shape, thereby manipulating the incoming air charge into a vortex. While this design showed improvements over then existing technologies, the inventors hereof have found that certain improvements are still necessary to achieve better engine efficiency. Thus, there is still an apparent need for an improved throttle body spacing block that can increase gas mileage, increase horsepower, increase torque, and reduce emissions. Based upon these qualities, the present invention substantially fulfills these needs.

### BRIEF SUMMARY OF THE INVENTION

The present invention is directed to a throttle body spacing block device useful for increasing the combustion efficiency of an internal combustion engine, providing a higher fuel efficiency (e.g. more miles per gallon of fuel consumed) and reducing harmful greenhouse gasses found in engine exhaust. While it is understood that the invention may be particularly suitable for increasing the combustion efficiency of a diesel engine, it is understood that the invention may be used with any and all engines, including natural gas powered, propane powered, bio-diesel fuel powered, and natural aspirated gasoline powered engines. The present invention reduces the creation of harmful emissions on the front end of the combustion chamber, which greatly reduces the amount of harmful emissions emitted into the atmosphere.

Furthermore, unlike many previously developed throttle spacing blocks, the device of the present invention provides a grooved aperture that serves to increase the velocity of the air charge and turbinate the air charge as it passes through the aperture. In one embodiment, the grooved nature of the aperture is provided through the use of a series of individual, angled rings of different diameters that are interstacked in a concentric and parallel manner such that the angled surfaces of the rings create a continuously grooved inner surface throughout the aperture.

It may be seen, then that an object of the present invention is to provide a new and improved throttle body spacing block for any and all internal combustion engines which has all of the advantages of the prior art spacing blocks and none of the disadvantages. Furthermore, it is an object of the present invention to provide new and improved spacing block for any and all internal combustion engines which may be easily and efficiently manufactured and marketed. Finally, it is an object of the present invention to provide a new and improved throttle body spacing plate applicable to any and all internal combustion engines which is adapted to be interconnected to the intake manifold of an internal combustion engine. The present invention with its specially designed grooved aperture(s) act to increase the distance the incoming air charge travels before it enriches the fuel mixture and to cause the incoming air charge to turbinate thereby creating an air vortex. These two effects, the increased distance traveled and the air vortex, act to effect higher air velocity and air turbulence. This, in turn, creates a more oxygenated fuel supply. A more oxygenated fuel supply creates more efficient fuel combustion. Preferably, the device of the present invention is configured to newly manufactured and installed with new automobile and other engines or to be retrofit upon existing intake manifolds of internal combustion engines.

These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a top-view drawing of one embodiment of the device of the present invention.

FIG. 2 is a bottom-view drawing of one embodiment of the device of the present invention.

FIG. 3 is a top-view drawing of one embodiment of the device of the present invention showing the diameter of the passageway top opening.

FIG. 4 is a bottom-view drawing of one embodiment of the device of the present invention showing the diameter of the passageway bottom opening.

FIG. 5 is a schematic showing one embodiment of the device of the present invention with a generally tapered aperture resulting from relatively variable diameter sections.

FIG. 6 is a schematic showing one embodiment of the device of the present invention with a generally tapered aperture, showing the relatively variable diameters of the grooved sections of the aperture passageway.

FIG. 7 is a schematic showing one embodiment of the device of the present invention with a generally straight passageway resulting from relatively uniform diameter sections.

FIG. 8A is a top schematic view of one embodiment of the grooved aperture of the present invention, showing various diameters.

FIG. 88 is a side schematic view of one embodiment of the aperture of the grooved present invention, showing various diameters.

FIG. 9A is a top schematic view of one embodiment of the grooved aperture of the present invention, showing various diameters.

FIG. 9B is a side schematic view of one embodiment of the aperture of the grooved present invention, showing various diameters,

FIG. 10A is a top schematic view of one embodiment of the grooved aperture of the present invention, showing various diameters.

FIG. 10B is a side schematic view of one embodiment of the aperture of the grooved present invention, showing various diameters.

FIG. 11 is an annotated side view of a prior art aperture, showing the sloped, helical nature of the grooved sections.

FIG. 12 is an annotated side view of one embodiment of the aperture of the present invention, showing the flat, parallel nature of the grooved sections.

FIG. 13 is a top schematic view of one embodiment of the device of the present invention.

FIG. 14 is a to schematic view of another embodiment of the device of the present invention.

### DETAILED DESCRIPTION OF THE INVENTION

Generally speaking, the present invention is directed to a device for reducing the harmful emissions generated and emitted by combustion engines. The device may generally be described as a throttle body spacing block, as known in the art. In very general terms the present invention is a device that disturbs or manipulates the amount air flow in the engine, causing the air to flow in a different pattern and causing a heterogenous mixture to be more efficient at ignition. As noted above, while the present invention is suitable for use with a variety of different engine types, the invention may be particularly useful for use with diesel engines. Diesel engines are forced air engines. Air will fill any space that is not taken by mass. Therefore, as air is forced into an engine, the hotter air (which is less dense) will be found on the outer diameter inside the air intake tube. Being less dense allows hotter air flow to not be as easily disrupted, but it is far more manipulated by mass or structure. The device of the present invention introduces a structure such that as the hotter air meets the largest diameter of the device, the air will repel from the structure of the device. With forced air pushing it creates a continuous replication being air vortices. This effect allows for better atomization of fuel/air, improving the combustion efficiency and increasing the overall performance of the engine.

As noted above, the use of throttle spacing blocks with aperture(s) Is known in the art. However, it is the specific design and function of the aperture of the device of the present invention that provides the principal concept. Still, for clarity, the remaining components of the device may be described generally below. It is understood, of course, that in various embodiments the general shape of the device body may be modified in order to be used with engines of different sizes, shapes, and configurations, so long as the design and function of the aperture remains substantially as described herein.

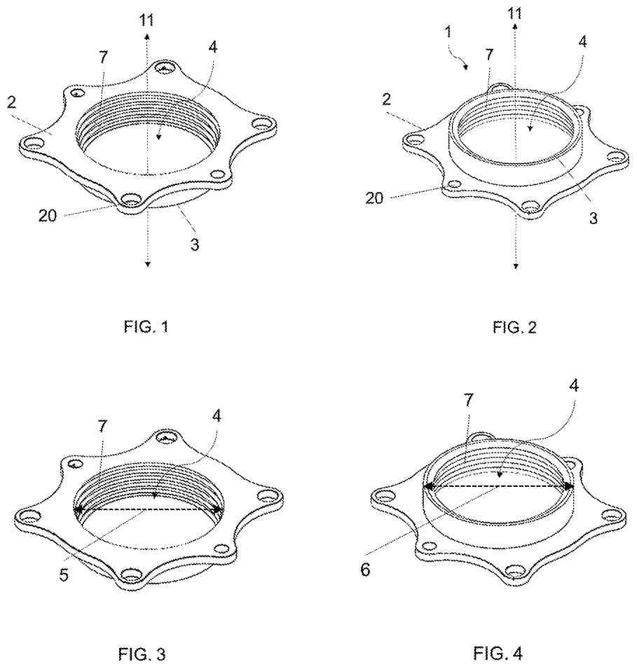

Generally speaking, the device of the present invention is a throttle spacing block, which may generally be described as a small metal circle configured to be installed in between the throttle body and intake system of an engine, effectively lengthening the intake manifold to create a small amount of extra space for air movement. Turning to FIGS. 1-108, various embodiments of the device of the present invention may be described. As shown in FIG. 1, the device of the present invention generally includes a body portion with a top end surface and a bottom surface 3, where the top surface 2 is preferably configured to be positioned adjacent the throttle body and the bottom surface 3 is preferably configured to be positioned adjacent the intake system, such that the aperture 4 of the device acts as a passageway for air moving from the throttle body into the intake system. (Alternatively, the device may be installed in the opposite direction such that the top surface 2 is configured to be positioned adjacent the intake system and the bottom surface 3 is configured to be positioned adjacent the throttle body. In any event, the aperture 4 acts as an air passageway between the two engine components). The top surface 2 and bottom surface 3 are substantially parallel to one another as to create an axis 11 extending from the top surface 2 to the bottom surface 3. One or more aperture(s) 4 extends through the device along the axis 11 from the top surface 2 to the bottom surface 3, thereby acting as a passageway through the device. In the preferred embodiment, the aperture 4 has a generally circular cross-section such that the passageway is generally cylindrical in shape. It is understood, however, that the cross section can be of a variety of shapes, including, for example oval, hexagon, triangle or other shape. In addition, the aperture 4 can be spline cut such that the cross section is one of a variety of shapes with splines (teeth or ridges) along the outer perimeter. In any event, because the aperture 4 creates a hollow passageway through the device 1, the passageway is presented with an internal surface 7, which is preferably grooved according to the specifications described below. It is understood that the general shape of the top surface 2 and bottom surface 3 may be modified in order to mirror the shape of the existing components between which the device 1 sits (as to fit securely adjacent to those components to form the air passageway between the components), and a hole 20 pattern on the surfaces may be modified depending on the retrofit to allow the device 1 to be mounted securely to the engine components.

In the preferred embodiment, the internal surface 7 of the passageway is configured to be grooved as to increase the distance the incoming air charge travels before it enriches the fuel mixture and to cause the incoming air charge to turbinate, thereby creating vortices. Unlike the helical nature of the grooved aperture presented in the '335 patent, the grooved 7 passageway 4 of the present invention may be described as being formed from a series of concentric and parallel sections or rings 8 formed in such a manner that passageway 4 has what may be generally described as a series of parallel grooved sections, as shown. In the preferred embodiment, as noted above, the aperture 4 has a generally circular cross section. The surface of each section 8 is sloped such that the section 8 generally forms a conical frustum such that the passageway is in theory a series of conical frustums stacked upon one another to form the passageway. That is, while the helical threading of the passageway in the '335 patent, as shown for example in FIG. 11 results in a series of grooves that slope across the passageway (e.g. slope from the left of FIG. 11 to the right of FIG. 11), the grooved 7 sections 8 of the present invention are flat across the section itself and therefore are not helical in the manner shown in the '335 patent (compare FIG. 12, showing the grooved passageway 4 of the present invention, with FIG. 11, showing the grooved passageway of the invention presented in the '335 patent). As noted previously, it is understood that the cross-section of the passageway can be of any number of shapes so long as the passageway is generally formed of a series of concentric and parallel grooved sections 8. In this regard, it may be seen, for example, in the case of a hexagonal cross-section, each of the sections 8 may form a hexagonal frustum, as the walls slope as the diameter of the grooved section increases or decreases.

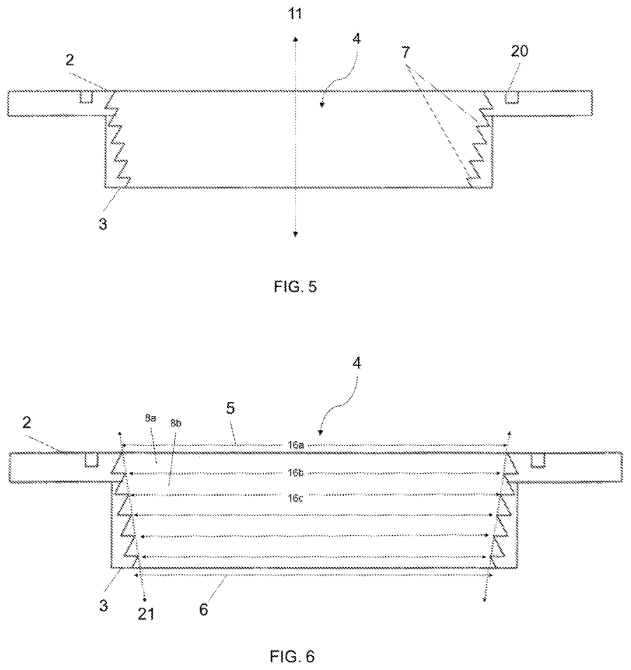

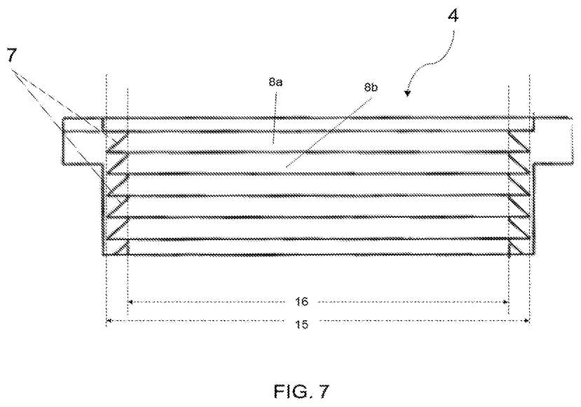

In the preferred embodiment the grooved sections 8 of the passageway 4 may each have a major diameter 15 and a minor diameter 16. The minor diameter 16 of each section is formed as the pointed edge of the grooved surface 7 move closer together, while the major diameter 15 is caused by the sloped nature of the grooved surface 7. For example, as shown in FIGS. 6 and 7, the sections 8 have a minor diameter 16. The diameter of the section increases incrementally until the major diameter 15 is reached, after which the edges of the grooved surface form the new minor diameter 16 for the next section 8. Likewise, the aperture may be said to have a top diameter 5 of the top opening and a bottom diameter 6 of the bottom opening. In some cases the top diameter 5 and/or bottom diameter 6 may be dictated by the major diameter 15 and/or minor diameter 16, or may be different according to desired specifications. In one embodiment, each grooved section may be cut at an angle (such as a 45 degree or 60 degree angle) to provide a generally conical frustum shape for each grooved section. It is also contemplated that the height of each section may be modified as desired.

In one embodiment, the average diameter of each grooved section 8 may differ, with each grooved section 8 having a major diameter and minor diameter 16 different than those of the other grooved sections 8, as shown for example in FIGS. 5-6. This varying diameter at each grooved section 8 creates a general taper 21 in the passageway 4. Each section 8 beings with a minor diameter 16 that is smaller than the minor diameter 16 of the previous section 8. In addition, for each particular section 8, the diameter in each section 8 increases incrementally to reach the major diameter 15 of the section 8 before the diameter decreases again to reset at the minor diameter 16 of the next section 8. Thus, it may be seen that each grooved section 8 is tapered from smaller diameter to larger diameter, but the overall passageway 4 is tapered from a generally larger average diameter to a generally smaller average diameter. This is shown, for example, in FIG. 6, where the first section 8a has a minor diameter 16 (which, in this particular case happens to be the same as the top opening diameter 5) and the sloped surface 7 results in incrementally increasing diameter until the minor diameter 16b of the next section 8b is reached. The minor diameter 16 of the second section 8b is smaller than the minor diameter 16a of the first section 8a, resulting in the overall taper 21 of the passageway 4 from the top opening diameter 6 to the bottom opening diameter 6. In one embodiment (not shown), it may be seen that the average diameter of the sections increases from the top of the passageway to the bottom. In this regard, it may be seen that the passageway is presented with a reverse taper as it becomes wider towards the bottom than at its narrower top.

For example, it may be seen that the major diameter for the first section is 3.9848 Inches, while the major diameter for the second section is 3.9189 inches, the major diameter for the third section is 3.8540 Inches, the major diameter for the fourth section is 3.7891 inches, the major diameter for the fifth section is 3.7242 inches, and the major diameter for the final section is 3.4482 inches. Preferable, each section is about 0.1800 inches. Of course, the minor diameter of each section also decreases incrementally as to provide the general tapered shape 21 of the passageway.

In alternative embodiments, as shown in FIGS. 7-10B, for example, the grooved sections 8 of the passageway 4 of the device may be uniform in size relative to one another, with each grooved section 8 having the same minor diameter 16 and same major diameter 15 (and a series of incrementally increasing diameters positioned there between as a result of the angled nature of the internal surface 7 of the angled ring sections 8). It may be seen, then, that the diameter along the length of the passageway will move between the minor diameter 16 and a major diameter 15 and incremental diameters 14 therebetween as the diameter of each grooved section incrementally changes, but the overall shape of the passageway is straight instead of tapered like in the previous embodiment.

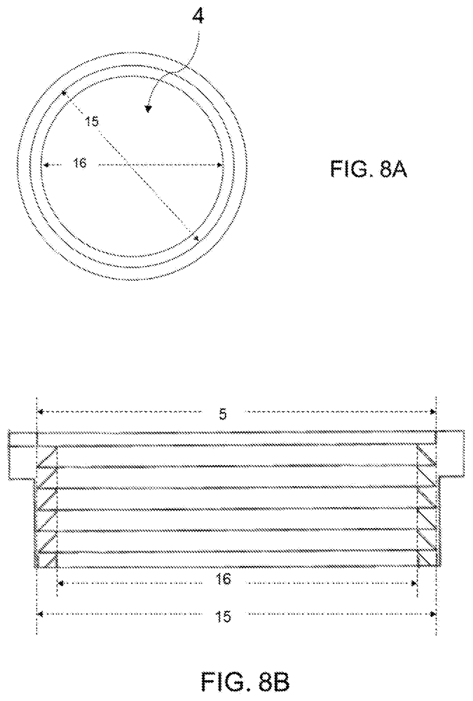

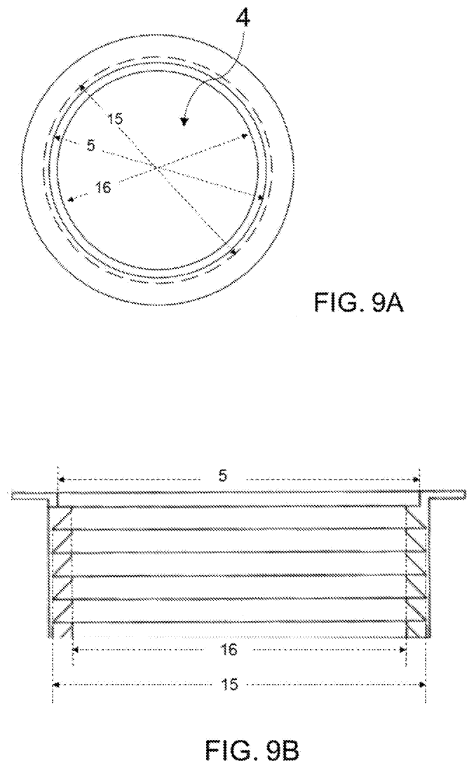

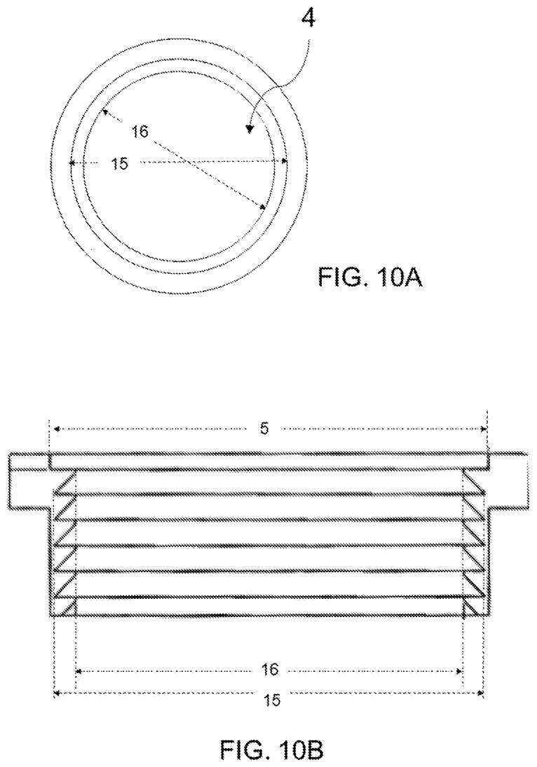

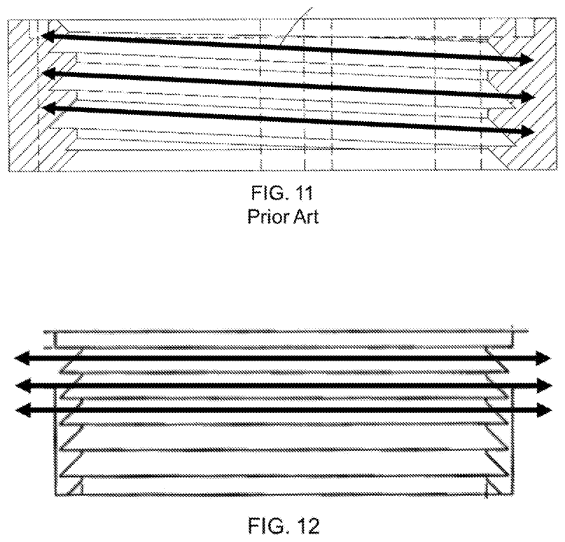

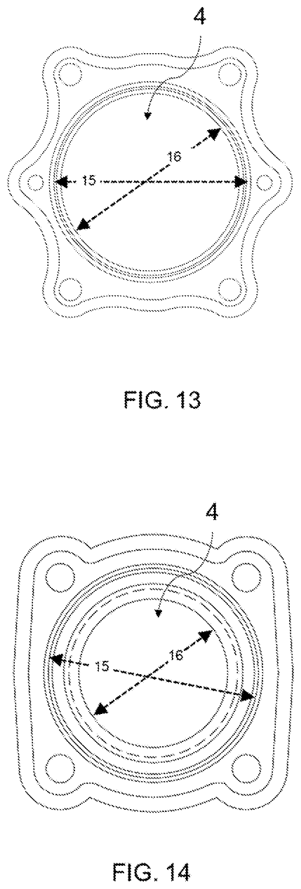

As shown in the various embodiments of FIGS. 8A-10B, it is contemplated that the diameters can be modified as desired. In one embodiment, for example, the major diameter 15 of the sections 8 and the diameter of the top opening 5 may be substantially the same, as shown in FIGS. 8A-8B. Here, for example, the top opening diameter 5 and the major diameter 15 of the sections 8 may be equal to 3.522 inches. In addition, the minor diameter of the sections 8 may be equal to 3.1220 inches, with the diameter of each section incrementally increasing from the 3.1220 inches of the minor diameter 16 to the 3.522 inches of the major diameter. Alternatively, the major diameter 15 of the sections 8 may be larger than the diameter of the top opening 5, as shown for example in FIGS. 9A-98. Here, for example, the top opening diameter 5 may be 3.0310 inches, while the major diameter 15 of the sections 8 may be 3.2380 inches, and the minor diameter 16 of the sections 8 may be 2.8981 inches. In yet another embodiment, as shown for example in FIGS. 10-10B, the major diameter 15 of the sections 8 may be smaller than the diameter of the top opening 5. In any event, regardless of the modifications made to the various diameters, it may be seen that the grooved rings 8 provide structure for manipulating the airflow as it travels through the passageway 4.

The device of the present invention is installed at or within minimum distance to the air intake manifold of the engine. In one embodiment, the device is designed to be installed inside the air intake tube which downstream connects to the engine air intake manifold. The before intake tube can and is manufactured from various materials depending upon the application. In one embodiment, the device may be installed as a bolt-on application, and in this embodiment, the device bolts directly to the intake manifold using the holes 20 in the device body. In one embodiment, the device is bolted directly to the intake with the full body of the device being physically located externally of the manifold (this may be referred to as “Application A”). In an alternative embodiment, the device is bolted directly to the manifold and is visibly installed as an external component but the physical existence is positioned as a “drop-in” style into the manifold while the flange is bolted to the outer surface of the manifold (this may be referred to as “Application B”). Wherever and however the installation process may be, installation of the device should be between the engine outside air intake and the internal combustion chamber.

It is understood that the device of the present invention may be sold either alone or with two different styles of hardware kits depending on the application. Likewise, the device may be installed alone or using one of the two different hardware kits. Each hardware kit contains only the fasteners and seals. If sold with both hardware kits, each of the hardware kits may be designated a label (such as kit “A” and kit “B”) to allow for appropriate installation instructions to accompany the chosen installation kit. The first kit, kit A, utilizes a 9/16 in width band clamp. Kit B utilizes four 10 mm diameter, 35 mm length bolts (preferably zinc coated/grade 5), four 10 mm flat washers, and one #235 “O”-ring (oil and high temp resistant). It may be seen that installation kit A is particularly useful for installation according to Application A and kit B is particularly useful for installation according to Application B.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A device for manipulating airflow into an intake manifold of an internal combustion engine, the device comprising an aperture configured to act as a passageway for airflow through the device, further wherein the aperture comprises an interior surface having a series of concentric and parallel grooved sections, wherein each of the grooved sections comprises an angled inner surface, thereby forming a series of concentric and parallel conical frustum grooved sections, wherein the series of concentric and parallel conical frustum grooved sections is configured to manipulate the airflow through the device.

2. The device of claim 1, wherein each of the number of grooved sections has a major diameter and a minor diameter.

3. The device of claim 2, wherein the minor diameter for each of the grooved sections is equal to the minor diameter of each other grooved section, thereby forming a generally straight passageway.

4. The device of claim 2, wherein the minor diameter of each of the grooved section is different than the minor diameter of each other grooved section, thereby forming a generally tapered passageway.

5. The device of claim 1 wherein the series of concentric and parallel grooved sections is formed from a number of angled rings.

6. The device of claim 1 wherein the series of concentric and parallel grooved sections comprises a circular cross-section.

7. A device for manipulating airflow into an intake manifold of an internal combustion engine, the device comprising an aperture configured to act as a passageway for airflow through the device, further wherein the aperture comprises an interior surface configured to manipulate airflow through the aperture, further wherein the internal surface comprises a generally tapered configuration, further wherein the generally tapered configuration is formed by a series of interstacked conical frustum rings forming grooved sections of incrementally changing diameters.

8. (canceled)

9. The device of claim 7, wherein each of the series of grooved sections comprises a minor diameter.

10. The device of claim 9, wherein the minor diameters of the series of grooved sections becomes increasingly smaller from a first grooved section in the series of grooved sections to a last grooved section in the series of grooved sections, thereby creating a tapered aperture.

11. The device of claim 9, wherein the minor diameters of the series of grooved sections becomes increasingly larger from a first grooved section in the series of grooved sections to a last grooved section in the series of grooved sections, thereby creating a reverse tapered aperture.

12. The device of claim 8, wherein the series of grooved sections are concentric and parallel.

13. A device for manipulating airflow into an intake manifold of an internal combustion engine, the device comprising an aperture configured to act as a passageway for airflow through the device, further wherein the aperture comprises an interior surface formed from a series of individual angled rings interstacked in a concentric and parallel manner thereby creating a series of conical frustum shaped grooved sections, wherein the series of conical frustum grooved sections is configured to manipulate the airflow through the device, and wherein each of the individual angled rings comprises an inner surfaced angled at one of a 45-degree angle and a 60-degree angle.
